(19) United States
(12) Patent Application Publication
(10) Pub. No.: US 2008/0005785 A1
(43) Pub. Date: Jan. 3, 2008

(54) Usage of nonce-based authentication scheme in a session-based authentication application

(75) Inventors: Anu Leinonen, Tampere (FI); Gabor Ungvari, Gyal (HU)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/808,372

(22) Filed: Jun. 8, 2007

Related U.S. Application Data
(60) Provisional application No. 60/814,058, filed on Jun. 16, 2006.

(51) Int. Cl. H04L 9/32

(52) U.S. Cl. 726/3

(57) ABSTRACT

Usage of nonce-based authentication scheme in a session-based authentication application, usable in a communication system comprising a session control server and an authentication server, which are configured to provide for a session-based authentication application, wherein authentication is based on a nonce-based authentication scheme, comprising an indication of an operation mode of the session control server from the session control server to the authentication server in an authentication request, wherein the operation mode included proxy mode and user agent mode.

### CROSS REFERENCE TO RELATED APPLICATION

This application claims priority of U.S. Provisional Patent Application Ser. No. 60/814,058 filed on Jun. 16, 2006, the entire contents of which are incorporated herein by reference.

### FIELD OF THE INVENTION

The present invention relates to a usage of a nonce-based authentication scheme in a session-based authentication application. In particular, the present invention relates to authentication in a communication system comprising a session control server and an authentication server, which are configured to provide for a session-based authentication application, wherein the authentication is based on a nonce-based authentication scheme.

### BACKGROUND OF THE INVENTION

In present-day and future communication systems such as for example GPRS (General Packet Radio Service), UMTS (Universal Mobile Telecommunication Service) or CDMA (Code Divisional Multiple Access), authentication and authorization represent essential issues.

For ensuring security and trustiness within such communication systems, which is particularly important for functions and services related to security-relevant, personal and/or confidential data and services, and for controlling access to such network systems and parts thereof, a user authentication is usually performed. To this end, several authentication, authorization and accounting (AAA) methods have been proposed. The applicability of such AAA methods, however, depends on underlying network concepts and/or technologies of the communication system.

For example, the 3^{rd} Generation Partnership Project (3GPP) has specified a so-called IP Multimedia Subsystem (IMS). The IP Multimedia Subsystem comprises, among others, a home subscriber server (HSS), several call state control functions (CSCF; CSCSF's being divided into proxy, interrogating and serving CSCF's) and a server locator function (SLF). On the interfaces between these network entities, referred to as Cx and Dx interfaces, a Diameter protocol according to a Diameter Base Protocol as defined in RFC3855, particularly in sections 1 and 2 thereof, is used for authentication purposes.

In an IMS network, the session initiation protocol (SIP) specified by the Internet Engineering Task Force (IETF) is usually employed as a session control protocol. Hence, the HSS may be referred to as a Diameter server and the (S-)CSCF's may be referred to as SIP servers. In this connection, the IMS defines a Diameter application to interact with the SIP signaling during session setup and other ones to perform and/or control other SIP services. As defined in sections 8 and 16 of RFC3261, a SIP server may operate in a user agent mode, thus representing an end system, or in a proxy mode, thus representing an intermediary between user agent server and client.

In this regard, there has been proposed a Diameter SIP application in the Internet-draft “draft-ietf-aaa-diameter-sip-app-12” of Apr. 28, 2006 (already being approved by the IETF as an RFC, the number of which is not yet known). This proposal describes an interworking of Diameter and SIP in that a SIP server relies on Diameter AAA infrastructure for authenticating a SIP request (for example, a SIP registration request such as SIP REGISTER) and authorizing the usage of particular SIP services. The Diameter SIP application provides a Diameter client being co-located with a SIP server, with the ability to request the authentication of users and authorization of SIP resources usage from a Diameter server. Pursuant to different operations of the Diameter SIP application, an actual authentication is either performed at a Diameter server or at a Diameter client (i.e. SIP server).

In the following, the Diameter SIP application is referred to as a non-limiting example for a session-based authentication application.

Furthermore, there has been proposed a solution for providing security, i.e. authentication, for IP-related network environments, which is usually referred to as “HTTP Digest authentication”. This solution is e.g. disclosed in RFC2617, and utilizes cryptographic hashes for authentication. For example, the above-mentioned Diameter SIP application supports HTTP Digest as the only authentication scheme in session control according to SIP. The Digest scheme is based on a simple challenge-response paradigm using a nonce value for challenging, a nonce (“number used once”) being a (pseudo) random number used for authentication.

In the following, the HTTP Digest authentication is referred to as a non-limiting example for a nonce-based authentication scheme.

As regards an interaction of e.g. HTTP Digest with Diameter SIP for authenticating a user, the following procedures apply.

When a SIP server wants to authenticate a SIP user agent client (e.g. a user equipment), the SIP server may acquire user-related authentication and authorization data from a Diameter server. As mentioned above, a certain SIP server has to co-locate a Diameter client, when it wants to get user information from a Diameter server. During authentication of a certain SIP user agent client (UAC), the Diameter client in the SIP server has to send a request and process a response to and from a proper Diameter server.

When the Diameter client wants to get authentication information for the user agent client to be authenticated or wants to authenticate the user agent client, then the Diameter client sends an authentication request, known as Multimedia-Auth-Request (MAR command), along with available user data to the Diameter server. The Diameter server as a response sends an authentication response, known as Multimedia-Auth-Answer (MAA command), along with user authentication data or sends a result of an authentication, which in this example case is performed by means of HTTP Digest. In dependence on the fact, whether the authentication is performed at the Diameter server or at the Diameter client (i.e. SIP server), either two pairs of MAR/MAA commands or one pair of MAR/MAA commands are exchanged.

The HTTP Digest authentication requires a nonce generated by a server, in this case the Diameter server. This nonce is generated by the Diameter server in the framework of the Diameter SIP application. Besides a nonce value it is also possible to use a nonce count value for the case of nonce reuse in HTTP Digest authentication.

A new nonce can be issued either with a 200 (OK) response or by sending a 401 (Unauthorized) or a 407 (Proxy Authentication Required) response. It depends on an operation mode of the SIP server, i.e. user agent mode or proxy mode, which nonce option is applicable. Whenever the SIP server is operating in user agent mode, i.e. as a user agent server, it sends a new nonce in each 200 (OK) response, because it is preferable to use a fresh nonce in each request instead of updating a nonce count value. Whenever the SIP server is operating in proxy mode, it prefers to avoid extra roundtrip delay of challenging by nonce count value usage. Thus, the SIP server sends a new nonce, an operator policy of nonce usage counter and nonce lifetime actually trigger that a nonce value cannot be used anymore.

However, there is a problem in that the Diameter server, which is expected to generate a nonce for the authentication, is not able to apply HTTP Digest procedures correctly. If a Diameter server is assigned to manage nonce state with nonce count value allocated to a certain user (which is up to an operator policy, but is beneficial in order to avoid replay attacks), the Diameter server thus has no information (after a successful authentication), whether a new nonce should be generated or a nonce count should be updated.

This can be detrimental as it may result in that, after a successful authentication, a Diameter server drops an old nonce (used in the previous authentication) and generates a new nonce and a Diameter server expects from the SIP server to send new nonce in a “nextnonce” parameter. However, it may happen that the SIP server works as a SIP proxy server and has no possibility to utilize a new “nextnonce” nonce generated by the Diameter server. However, the Diameter server should assume that the SIP client (i.e. user agent client) would use a “nextnonce” based on the SIP protocol. Therefore, when the user agent client (e.g. a user equipment) next time sends a request with an HTTP Digest response using an old nonce (with increased nonce count), then a pre-generated authentication response would be wrong. This results that the request will be challenged by the SIP server based on a Diameter server response using a new nonce.

Although this behavior does not prevent the user agent client from registering and using the SIP server, the benefits of using nonce count and “nextnonce” in HTTP Digest authentication are lost. This leads to increased network traffic for both the SIP server and the Diameter server.

Thus, a solution to the above problems and drawbacks is needed for providing an efficient usage of nonce-based authentication scheme in a session-based authentication application.

### SUMMARY OF THE INVENTION

It is a concern of the present invention to remove the above drawbacks and to provide accordingly improved methods, apparatuses and the like.

According to one aspect of the invention, there is provided a method of authentication as described in the following.

According to one aspect of the invention, there is provided an apparatus for a session control server's side as described in the following.

According to one aspect of the invention, there is provided a method of operating an apparatus according to the second aspect as described in the following.

According to one aspect of the invention, there is provided an apparatus for an authentication server's side as described in the following.

According to one aspect of the invention, there is provided a method of operating an apparatus according to the fourth aspect as described in the following.

According to one aspect of the invention, there is provided a system of authentication as described in the following, wherein the system in one implementation basically comprises an apparatus according to the second aspect and an apparatus according to the fourth aspect.

According to further aspects of the invention, there are provided computer programs and data structures to operate the above-mentioned apparatuses, either each one alone or in any combination, as described in the following.

Basically, the invention comprises an indication of an operation mode of a session control server from that session control server to an authentication server, wherein conceivable operation modes are a proxy mode and a user agent mode. Further, the invention comprises an application of nonce-based authentication procedures in view of an operation mode of a session control server. Additionally, the invention comprises a spreading of authentication parameters in dependence on an operation mode of a session control server.

According to embodiments of the present invention, the cooperation between a session control server and an authentication server is improved. Accordingly, the authentication server obtains knowledge about the type of authentication mode used by the session control server, i.e. user-to-user mode or proxy-to-user mode.

By way of embodiments of the present invention, a synchronization on session control level like SIP level is achievable between a session control server like a SIP server and an authentication server like a Diameter server, when a nonce-based authentication scheme is used in a session-based authentication application.

It is another facet of embodiments of the present invention that a usage of a nonce-based authentication scheme such as e.g. HTTP Digest in a session-based authentication application such as e.g. Diameter SIP application is enabled. This results in that a user agent client can utilize any possible feature of a nonce-based authentication scheme in a session-based authentication framework in each case of operation mode of a session control server.

Thereby, network traffic is reduced by embodiments of the present invention.

### BRIEF DESCRIPTION OF THE DRAWINGS

In the following, the present invention will be described in greater detail with reference to the accompanying drawings, in which

FIG. 1 shows a signaling flow diagram of a method according to an embodiment of the present invention, and

FIG. 2 shows a block diagram of a system according to an embodiment of the present invention.

### DETAILED DESCRIPTION OF EMBODIMENTS OF THE PRESENT INVENTION

The present invention is described herein with reference to particular non-limiting examples. A person skilled in the art will appreciate that the invention is not limited to these examples, and may be more broadly applied.

In particular, the present invention is described in relation to usage of HTTP Digest authentication in a SIP Diameter application framework as an example implementation. As such, the description of the aspects and embodiments given herein specifically refers to terminology which is directly related to this example. Such terminology is, however, only used in the context of the presented examples, and does not limit the invention in any way.

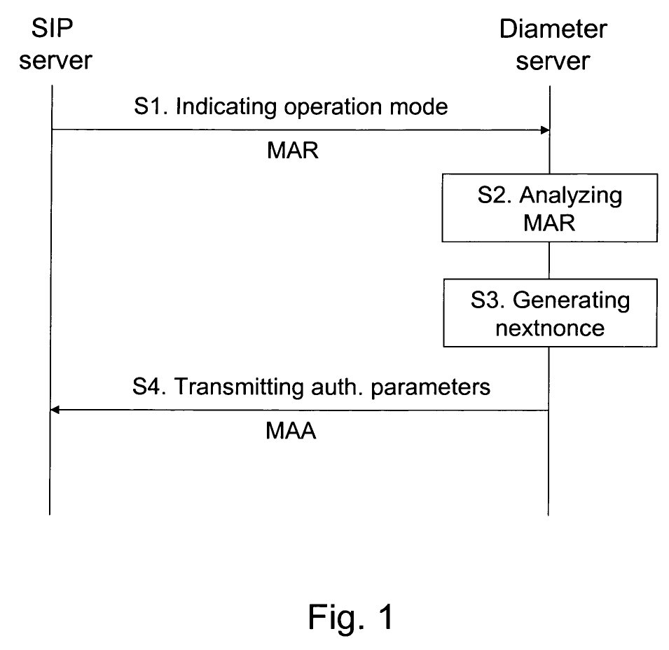

FIG. 1 shows a signaling flow diagram of a method according to an embodiment of the present invention. In FIG. 1, only those messages and operations are depicted, which are relevant for the description of embodiments of the present invention.

It is to be noted that a SIP server shown in FIG. 1 may either be a SIP server directly receiving a SIP request (e.g. registration) from a user, or a (local) SIP server receiving a SIP request (e.g. registration) being forwarded from another SIP server which is not appropriate for the respective request/user.

As shown in FIG. 1, a SIP server (at which a Diameter client is co-located) requests user authentication from a Diameter server and indicates its operation mode towards the Diameter server, with which the SIP server cooperates for providing a Diameter SIP application (step S1). This step may for example be conducted after a successful authentication of a user (not shown) acting as a user agent client, or upon receipt of an authentication request from a user at the SIP server, or at any other suitable occasion in an authentication process. According to implementations of the invention, which are described below, the operation mode of the SIP server may be proxy mode, in which the SIP server represents an intermediary between a user agent client (UAC) and a user agent server (UAS), or user agent mode, in which the SIP server represents a user agent server (UAS).

In FIG. 1, the indication of the operation mode is illustrated to be transmitted in an authentication request being denoted by MAR (MAR: Multimedia-Auth-Request). The message format of an MAR command is defined in section 8.7 of the above-mentioned Internet-Draft of the Diameter SIP application.

Upon receipt of such an operation mode indication from the SIP server, the Diameter server analyzes the contents of the MAR command in accordance with one of implementation alternatives as set out below (step S2). In step S3, the Diameter server according to the illustrated embodiment generates a nonce and possibly also another nonce for a subsequent authentication, hereinafter referred to as “nextnonce”. The generation of nextnonce is based on, thus taking into consideration, the indicated operation mode of the session control server and, if applicable, also on other Digest parameters available. As set out above, either a new nonce is created or a nonce count value is updated at the Diameter server managing the nonce state. The kind of nextnonce generated basically depends on the operation mode of the SIP server such that a new nonce is usually generated, when the SIP server operates in user agent mode, and a nonce count value is updated, when the SIP server operates in proxy mode.

Thereupon, in step S4, the Diameter server transmits to the SIP server authentication parameters (possibly including the nonce generated) based on the previous analysis of step S2 and/or the previous generation of step S3. In FIG. 1, the transmission of the authentication parameters is illustrated to be effected in an authentication response being denoted by MAA (MAA: Multimedia-Auth-Answer). The message format of an MAA command is defined in section 8.8 of the above-mentioned Internet-Draft of the Diameter SIP application.

Among others, the MAA message includes a Digest-HA1 AVP that contains H(A1) (as defined in RFC 2617), and that allows the Diameter client to calculate the expected response. The presence of the Digest-HA1 AVP indicates to the SIP server (i.e. Diameter client) that the user authentication has to take place there. Then the SIP server can authenticate the user using the received parameters.

Although not shown in FIG. 1, the Diameter server, in addition to or instead of the transmission, may also perform an authentication using the HTTP Digest authentication scheme in the Diameter SIP application framework based on one or more of the above steps.

It is to be noted that the method flow depicted in FIG. 1 is only one example flow, but a method according to another embodiment of the present invention may as well comprise only one or some of the steps illustrated or may comprise other steps in-between or in another order.

With regard to the two cases mentioned above (i.e. authentication being performed in the Diameter client or in the Diameter server), the embodiment of FIG. 1 relates to the first case. However, although not depicted, embodiments of the present invention are also applicable to the second case, i.e. that the Diameter server performs the user authentication. In this case, two pairs of MAR/MAA commands are exchanged between Diameter client and server. Thereby, the first MAA command contains a nonce and the second MAA command contains a nextnonce, both being generated at the Diameter server in accordance with above-described principles. The operation mode indication of step 1 of FIG. 1 can in this case be effected with the first or the second MAR command, and the functions of steps 2 and 3 of FIG. 1 can in this case be effected during the first or second MAR/MAA command roundtrip.

According to a first implementation alternative of one embodiment, an indication is effected by using an attribute-value-pair (AVP) in the MAR message, which is specifically assigned for indicating a session control server mode. That is, a new AVP in addition to those as defined in the current Internet-Draft is introduced, thus forming a new data structure.

Such a newly introduced Diameter AVP, wherein AVP is a specific but non-limiting term for a message field, represents a SIP-Server-UA-mode AVP, which can indicate towards the Diameter Server whether the SIP server is working in proxy or in UA mode.

In this case, the Diameter Server can send a nextnonce in a SIP-Authentication-Info AVP, if the SIP-Server-UA-mode AVP indicates a SIP UA mode and HTTP Digest parameters enable usage of it. If the indicated SIP server mode in the new AVP is proxy mode, then the Diameter server should not send a SIP-Authentication-Info AVP, even if other Digest parameters would allow it.

This solution alternative provides a flexible way to populate a SIP server working mode, if needed. If not needed, then this AVP can be left from the MAR command sent from the SIP server (i.e. Diameter client). This alternative can also be used, if an authentication scheme other than HTTP digest is applied.

According to a second implementation alternative of one embodiment, an indication is effected by using a parameter, which is specifically assigned for indicating a session control server mode, within an attribute-value-pair, which is assigned for indicating a session control method. That is, a new parameter in addition to those as defined for a SIP-Method AVP in the current Internet-Draft is introduced, thus forming a new data structure.

Accordingly, an existing SIP-Method AVP is extended with indicating that a SIP request is being processed in proxy or in UAS mode in the SIP server. When the Diameter server receives such an MAR command, then it has to analyze the SIP server UA mode from this new parameter of the SIP-Method AVP. After a successful authentication, the Diameter server can decide, whether user-to-user or proxy-to-user HTTP Digest authentication should be applied.

According to a third implementation alternative of one embodiment, an indication is effected by using an attribute-value-pair, which is specifically assigned for indicating a session control server mode, if the session control server is in proxy mode, and using an attribute-value-pair, which is assigned for the session-based authentication application, if the session control server is in user agent mode. That is, the kind of indication used is distinguished on the basis of the operation mode of the SIP server. In this case, a new AVP in addition to those as defined in the current Internet-Draft is introduced for at least one condition, thus forming a new data structure.

Accordingly, new Diameter AVPs are defined for the purpose of a SIP proxy-to-user HTTP Digest authentication. These AVPs can for example be a SIP-Proxy-Authorization AVP and a SIP-Proxy-Authenticate AVP so as to match for SIP headers Proxy-Authorization and Proxy-Authenticate, respectively. For the purpose of a SIP user-to-user HTTP Digest authentication the already defined Diameter AVPs can be used. This means that already existing SIP-Authenticate/SIP-Authorization AVPs are matched for SIP headers WWW-Authenticate and Authorization, respectively. Also, an existing SIP-Authentication-Info AVP can be mapped to a SIP header Authentication-Info.

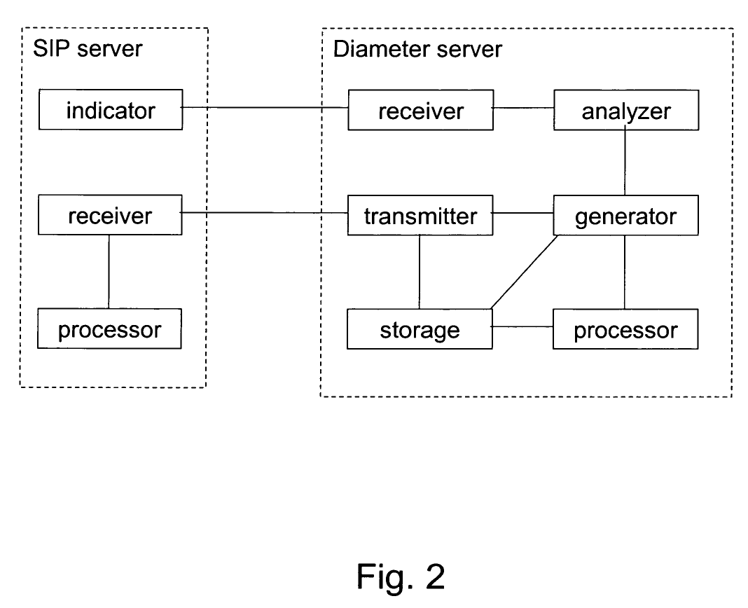

FIG. 2 shows a block diagram of a system according to an embodiment of the present invention. As shown in FIG. 2, a system of the present invention may comprise a SIP server and a Diameter server, or at least an apparatus in each of these servers, which operates according to the above-described method(s), respectively.

According to one embodiment, an apparatus at the SIP server side (which in FIG. 2 is exemplarily illustrated as the SIP server itself) comprises an indicator, i.e. means for indicating an operation mode (proxy or user agent mode) towards a Diameter server. Such an indicator is configured to use an authentication request such as an MAR command for the indication, and to use any one of the above-described implementation alternatives for this purpose. The apparatus further comprises a receiver, i.e. means for receiving authentication parameters transmitted from a Diameter server, and/or a processor, i.e. means for performing an authentication using the received parameters (possibly including a nextnonce).

According to one embodiment, an apparatus at the Diameter server side (which in FIG. 2 is exemplarily illustrated as the Diameter server itself) comprises a receiver, i.e. means for receiving an indication of an operation mode of a SIP server from the SIP server in an authentication request such as an MAR command. The apparatus may further comprise an analyzer, i.e. means for analyzing an authentication request from the SIP server. The analyzer is connected to the receiver and is configured to analyze received authentication requests in accordance with any one of the above implementation alternatives.

Further, there may be provided a generator, i.e. means for generating a nonce for a subsequent authentication in consideration of the result output from the analyzer, namely an indicated operation mode of the SIP server. A storage is provided for holding a nonce state with a nonce count value such that the Diameter server side is able to manage the nonce state. To this end, the storage is connected to the generator, from where newly generated values are input, to a processor, i.e. means for performing an authentication on the basis of generated and/or stored authentication parameters, and to a transmitter, i.e. means for transmitting respective authentication parameters to the SIP server.

For authentication purposes, the processors of both sides (although not shown) are enabled to cooperate in accordance with the authentication scheme used, in this case HTT Digest.

It is to be noted that FIG. 2 only illustrates those apparatuses, parts and elements, which are directly connected with an explanation of the present invention. It is to be understood by a skilled person which and how conventional apparatuses, parts and elements are also involved in practice.

The operation of any individual element of FIG. 2 will further be apparent to a skilled person when referring to the detailed description of the method according to FIG. 1. That is, the tangible embodiments of the present invention are configured to be operated in accordance with the method embodiments thereof. Therefore, special data structures and computer programs needed for implementing the present invention and its embodiments are also included by this invention.

In general, it is also to be noted that the mentioned functional elements, e.g. indicator and analyzer according to the present invention can be implemented by any known means, either in integrated or removable hardware and/or software, respectively, if it is only adapted to perform the described functions of the respective parts. For example, the analyzer can be implemented by any data processing unit, e.g. a microprocessor, being configured to analyze an authentication request in view of an operation mode indication as defined herein. The mentioned parts can also be realized in individual functional blocks or by individual devices, or one or more of the mentioned parts can be realized in a single functional block or by a single device. Correspondingly, the above illustration of FIG. 2 is only for illustrative purposes and does not restrict an implementation of the present invention in any way.

Furthermore, method steps likely to be implemented as software code portions and being run using a processor at one of the entities are software code independent and can be specified using any known or future developed programming language such as e.g. Java, C, C++, and Assembler. Method steps and/or devices or means likely to be implemented as hardware components at one of the peer entities are hardware independent and can be implemented using any known or future developed hardware technology or any hybrids of these, such as MOS, CMOS, BiCMOS, ECL, TTL, etc, using for example ASIC components or DSP components, as an example. Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to those skilled in the art.

According to embodiments of the present invention, a session control server, e.g. SIP server, indicates in an authentication request, e.g. MAR command, whether it is working in proxy mode or user agent mode from point of view of session control signaling. An authentication sever, e.g. Diameter server, receiving the indication then knows how to apply nonce-based authentication, e.g. HTTP Digest authentication, and how to populate parameters in an authentication response, e.g. MAA command, to the session control server.

The embodiments of the present invention are applicable in any communication system comprising a session control server and an authentication server, which are configured to provide for a session-based authentication application. This may for example be the case in an IMS system, where the present invention is particularly appropriate to be applied on the Cx interface. Other examples include systems defined by ETSI (European Telecommunication Standards Institute), 3GPP and 3GPP2 (3GPP: Third Generation Partnership Project) and TISPAN (Telecoms & Internet converged Services & Protocols for Advanced Networks).

In short, the above-described exemplary embodiments of the present invention could be summarized as an on-demand HTTP Digest nextnonce generation in a Diameter server.

In view of the forgoing it becomes clear that the present invention addresses several aspects of methods, entities and elements, which are as follows:

(First Aspect)

A method of authentication, usable in a communication system comprising a session control server and an authentication server, which are configured to provide for a session-based authentication application, wherein authentication is based on a nonce-based authentication scheme, the method comprising:

indicating an operation mode of the session control server from the session control server to the authentication server in an authentication request.

The above method, wherein the operation mode of the session control server includes a proxy mode and a user agent mode.

The above method, wherein indicating an operation mode is conducted before and/or after a successful authentication.

The above method, wherein according to a first option indicating an operation mode is effected by using an attribute-value-pair, which is assigned for indicating a session control server mode.

The above method, wherein according to a second option indicating an operation mode is effected by using a parameter, which is assigned for indicating a session control server mode, within an attribute-value-pair, which is assigned for indicating a session control method.

The above method, wherein according to a third option indicating an operation mode is effected by using an attribute-value-pair, which is assigned for indicating a session control server mode, if the session control server is in proxy mode, and using an attribute-value-pair, which is assigned for the session-based authentication application, if the session control server is in user agent mode.

The above method, further comprising:

analyzing, at the authentication server, an authentication request from the session control server; and

generating, at the authentication server, a nonce for a subsequent authentication in consideration of the indicated operation mode of the session control server.

The above method, wherein generating a nonce includes creating a new nonce and updating a nonce count value of a previous nonce.

The above method, further comprising:

transmitting authentication parameters in consideration of an indicated operation mode and/or a generated nonce from the authentication server to the session control server in an authentication response; and/or

performing authentication using the nonce-based authentication scheme in consideration of an indicated operation mode and/or a generated nonce.

(Second Aspect)

An apparatus, usable in a communication system comprising a session control server and an authentication server, which are configured to provide for a session-based authentication application, wherein authentication is based on a nonce-based authentication scheme, the apparatus comprising:

an indicator configured to indicate an operation mode of the session control server from the session control server to the authentication server in an authentication request.

The above apparatus, wherein the operation mode of the session control server includes a proxy mode and a user agent mode.

The above apparatus, wherein the indicator is configured to indicate an operation mode before and/or after a successful authentication.

The above apparatus, wherein according to a first option the indicator is configured to indicate an operation mode by using an attribute-value-pair, which is assigned for indicating a session control server mode.

The above apparatus, wherein according to a second option the indicator is configured to indicate an operation mode by using a parameter, which is assigned for indicating a session control server mode, within an attribute-value-pair, which is assigned for indicating a session control method.

The above apparatus, wherein according to a third option the indicator is configured to indicate an operation mode by using an attribute-value-pair, which is assigned for indicating a session control server mode, if the session control server is in proxy mode, and using an attribute-value-pair, which is assigned for the session-based authentication application, if the session control server is in user agent mode.

The above apparatus, further comprising:

a receiver configured to receive authentication parameters from the authentication server; and/or

a processor configured to perform authentication using the nonce-based authentication scheme based on received authentication parameters.

The above apparatus, wherein the authentication parameters comprise a nonce.

The above apparatus, wherein the apparatus is arranged at the session control server.

(Third Aspect)

A method of operating the above apparatus of the second aspect according to the method of the first aspect, wherein the apparatus acts as the session control server.

(Fourth Aspect)

An apparatus, usable in a communication system comprising a session control server and an authentication server, which are configured to provide for a session-based authentication application, wherein authentication is based on a nonce-based authentication scheme, the apparatus comprising:

a receiver configured to receive an indication of an operation mode of the session control server from the session control server in an authentication request.

The above apparatus, wherein the operation mode of the session control server includes a proxy mode and a user agent mode.

The above apparatus, further comprising:

an analyzer configured to analyze an authentication request from the session control server; and

a generator configured to generate a nonce for a subsequent authentication in consideration of the indicated operation mode of the session control server.

The above apparatus, further comprising a storage configured to hold a nonce state with a nonce count value.

The above apparatus, wherein the generator is configured to create a new nonce and to update a nonce count value of a previous nonce.

The above apparatus, further comprising:

a transmitter configured to transmit authentication parameters in consideration of an indicated operation mode and/or a generated nonce from the authentication server to the session control server in an authentication response; and/or

a processor configured to perform authentication using the nonce-based authentication scheme in consideration of an indicated operation mode and/or a generated nonce.

The above apparatus, wherein the apparatus is arranged at the authentication server.

(Fifth Aspect)

A method of operating the above apparatus of the fourth aspect according to the method of the first aspect, wherein the apparatus acts as the authentication server.

(Sixth Aspect)

A system of authentication, usable in a communication system comprising a session control server and an authentication server, which are configured to provide for a session-based authentication application, wherein authentication is based on a nonce-based authentication scheme, the system comprising:

an indicator configured to indicate an operation mode of the session control server from the session control server to the authentication server in an authentication request.

The above system, wherein the operation mode of the session control server includes a proxy mode and a user agent mode.

The above system, wherein the indicator is configured to operate as set out in connection with the above apparatus.

The above system, further comprising:

an analyzer configured to analyze an authentication request from the session control server; and

a generator configured to generate a nonce for a subsequent authentication in consideration of the indicated operation mode of the session control server.

The above system, wherein the generator is configured to create a new nonce and to update a nonce count value of a previous nonce.

The above system, further comprising:

a transmitter at the authentication server and a receiver at the session control server, configured to transmit authentication parameters in consideration of an indicated operation mode and/or a generated nonce from the authentication server to the session control server in an authentication response; and/or

A processor configured to perform authentication using the nonce-based authentication scheme in consideration of an indicated operation mode and/or a generated nonce.

The above system, comprising the apparatus of the second aspect and/or the apparatus of the fourth aspect.

(Seventh Aspect)

A computer program embodied in a computer-readable medium comprising program code configured to operate an apparatus according to the second aspect.

(Eighth Aspect)

A computer program embodied in a computer-readable medium comprising program code configured to operate an apparatus according to the fourth aspect.

According to certain embodiments of the present invention, the subject-matter of the above aspects is configured such that:

the session-based authentication application comprises a Diameter SIP application, and/or

the nonce-based authentication scheme comprises an HTTP Digest authentication, and/or

the session control server comprises a SIP server and/or a Diameter client, and/or

the authentication server comprises a Diameter server.

According to further certain embodiments of the present invention, the subject-matter of the above aspects is configured such that:

the communication system comprises an IP Multimedia Subsystem (IMS), and/or

the session control server comprises a call state control function, and/or

the authentication server comprises a home subscriber server.

In summary, there is provided a usage of nonce-based authentication scheme in a session-based authentication application, usable in a communication system comprising a session control server and an authentication server, which are configured to provide for a session-based authentication application, wherein authentication is in consideration of a nonce-based authentication scheme, comprising an indication of an operation mode of the session control server from the session control server to the authentication server in an authentication request, wherein the operation mode included proxy mode and user agent mode.

Even though the invention is described above with reference to the examples according to the accompanying drawings, it is clear that the invention is not restricted thereto. Rather, it is apparent to those skilled in the art that the present invention can be modified in many ways without departing from the scope of the inventive idea as disclosed above.

What is claimed:

1. A method of authentication, usable in a communication system, the method comprising:
indicating an operation mode of the session control server from the session control server to the authentication server in an authentication request,
wherein the communications system comprises a session control server and an authentication server, wherein the session control server and the authentication server are configured to provide for a session-based authentication application, wherein authentication is based on a nonce-based authentication scheme.

2. The method according to claim 1, wherein the indicating an operation mode of the session control server includes a proxy mode and a user agent mode.

3. The method according to claim 1, wherein the indicating an operation mode is conducted at least one of before and after a successful authentication.

4. The method according claim 1, wherein the indicating an operation mode is effected by using an attribute-value-pair, which is assigned for indicating a session control server mode.

5. The method according claim 1, wherein the indicating an operation mode is effected by using a parameter, which is assigned for indicating a session control server mode, within an attribute-value-pair, which is assigned for indicating a session control method.

6. The method according to claim 1, wherein the indicating an operation mode is effected by using an attribute-value-pair, which is assigned for indicating a session control server mode, if the session control server is in proxy mode, and by using an attribute-value-pair, which is assigned for the session-based authentication, application if the session control server is in user agent mode.

7. The method according to claim 1, further comprising:
analyzing, at the authentication server, an authentication request from the session control server; and
generating, at the authentication server, a nonce for a subsequent authentication in consideration of the indicated operation mode of the session control server.

8. The method according to claim 7, wherein the generating a nonce includes creating a new nonce and updating a nonce count value of a previous nonce.

9. The method according to claim 7, further comprising at least one of:
transmitting authentication parameters in consideration of at least one of an indicated operation mode and a generated nonce from the authentication server to the session control server in an authentication response; and
performing authentication using the nonce-based authentication scheme in consideration of at least one of an indicated operation mode and a generated nonce.

10. The method according to claim 1, wherein the session-based authentication application comprises a Diameter session initiation protocol, SIP, authentication.

11. The method according to claim 1, wherein the nonce-based authentication scheme comprises a hypertext transfer protocol, HTTP, Digest authentication.

12. An apparatus, usable in a communication system comprising a session control server and an authentication server, the apparatus comprising:
an indicator configured to indicate an operation mode of the session control server from the session control server to the authentication server in an authentication request,
wherein the session control server and the authentication server are configured to provide for a session-based authentication application, wherein authentication is based on a nonce-based authentication scheme.

13. The apparatus according to claim 12, wherein the operation mode of the session control server includes a proxy mode and a user agent mode.

14. The apparatus according to claim 12, wherein the indicator is further configured to indicate an operation mode at least one of before and after a successful authentication.

15. The apparatus according to claim 12, wherein the indicator is further configured to indicate an operation mode by using an attribute-value-pair, which is assigned for indicating a session control server mode.

16. The apparatus according to claim 12, wherein the indicator is further configured to indicate an operation mode by using a parameter, which is assigned for indicating a session control server mode, within an attribute-value-pair, which is assigned for indicating a session control method.

17. The apparatus according to claim 12, wherein the indicator is further configured to indicate an operation mode by using an attribute-value-pair, which is assigned for indicating a session control server mode, if the session control server is in proxy mode, and by using an attribute-value-pair, which is assigned for the session-based authentication application, if the session control server is in user agent mode.

18. The apparatus according to claim 12, further comprising:
a receiver configured to receive authentication parameters from the authentication server; and
a processor configured to perform authentication using the nonce-based authentication scheme based on received authentication parameters.

19. The apparatus according to claim 12, wherein the authentication parameters comprise a nonce.

20. The apparatus according to claim 12, wherein the apparatus is arranged at the session control server.

21. The apparatus according to claim 20, wherein the session control server comprises at least one of a session initiation protocol, SIP, server and a Diameter client.

22. An apparatus, usable in a communication system comprising a session control server and an authentication server, the apparatus comprising:
a receiver configured to receive an indication of an operation mode of the session control server from the session control server in an authentication request,
wherein the session control server and the authentication server are configured to provide for a session-based authentication application, and wherein authentication is based on a nonce-based authentication scheme.

23. The apparatus according to claim 22, wherein the operation mode of the session control server includes a proxy mode and a user agent mode.

24. The apparatus according to claim 22, further comprising:
an analyzer configured to analyze an authentication request from the session control server; and
a generator configured to generate a nonce for a subsequent authentication in consideration of the indicated operation mode of the session control server.

25. The apparatus according to claim 24, further comprising a storage configured to hold a nonce state with a nonce count value.

26. The apparatus of claim 24, wherein the generator is further configured to create a new nonce; and update a nonce count value of a previous nonce.

27. The apparatus according to claim 24, further comprising at least one of:
a transmitter configured to transmit authentication parameters in consideration of at least one of an indicated operation mode and a generated nonce from the authentication server to the session control server in an authentication response; and
a processor configured to perform authentication using the nonce-based authentication scheme in consideration of at least one of an indicated operation mode and a generated nonce.

28. The apparatus according to claim 22, wherein the apparatus is arranged at the authentication server.

29. The apparatus according to claim 28, wherein the authentication server comprises a Diameter server.

30. A system of authentication, usable in a communication system comprising a session control server and an authentication server, the system comprising:
an indicator, at the session control server, configured to indicate an operation mode of the session control server from the session control server to the authentication server in an authentication request,
a receiver, at the authentication server, configured to receive an indication of an operation mode of the session control server from the session control server in an authentication request,
wherein the session control server and the authentication server are configured to provide for a session-based authentication application, and
wherein authentication is based on a nonce-based authentication scheme.

31. The system according to claim 30, wherein the operation mode of the session control server includes a proxy mode and a user agent mode.

32. The system according to claim 30, further comprising at the authentication server:
an analyzer configured to analyze an authentication request from the session control server; and
a generator configured to generate a nonce for a subsequent authentication in consideration of the indicated operation mode of the session control server.

33. The system according to claim 30, further comprising at least one of:
a transmitter at the authentication server and a receiver at the session control server, configured to transmit authentication parameters in consideration of at least one of an indicated operation mode, and a generated nonce from the authentication server to the session control server in an authentication response; and
a processor, at each one of the authentication server and the session control server, configured to perform authentication using the nonce-based authentication scheme in consideration of at least one of an indicated operation mode and a generated nonce.

34. The system according to claim 30, wherein the communication system comprises an Internet Protocol, IP, multimedia subsystem, IMS.

35. The system according to claim 34, wherein the session control server comprises a call state control function.

36. The system according to claim 34, wherein the authentication server comprises a home subscriber system.

37. An apparatus, usable in a communication system comprising a session control server and an authentication server, the apparatus comprising:
an indicator means for indicating an operation mode of the session control server from the session control server to the authentication server in an authentication request,
wherein the session control server and the authentication server are configured to provide for a session-based authentication application, wherein authentication is based on a nonce-based authentication scheme.

38. An apparatus, usable in a communication system comprising a session control server and an authentication server, the apparatus comprising:
a receiver means for receiving an indication of an operation mode of the session control server from the session control server in an authentication request,
wherein the session control server and the authentication server are configured to provide for a session-based authentication application, and wherein authentication is based on a nonce-based authentication scheme.

39. A computer medium encoded with a computer program for performing a method, the method comprising:
indicating an operation mode of a session control server from the session control server to an authentication server in an authentication request,
wherein the computer readable medium is usable in a communication system comprising the session control server and the authentication server,
wherein the session control server and the authentication server are configured to provide for a session-based authentication application, and
wherein authentication is based on a nonce-based authentication scheme.

40. A computer readable medium encoded with a computer program for performing a method, the method comprising:
receiving an indication of an operation mode of a session control server from the session control server at an authentication server,
wherein the computer readable medium is usable in a communication system comprising the session control server and the authentication server,
wherein the session control server and the authentication server are configured to provide for a session-based authentication application, and
wherein authentication is based on a nonce-based authentication scheme.
